(19) United States
(12) Patent Application Publication
(10) Pub. No.: US 2002/0065065 A1
(43) Pub. Date: May 30, 2002

(54) Method and system for applying line of sight IR selection of a receiver to implement secure transmission of data to a mobile computing device via an RF link

(76) Inventors: E. Michael Lunsford, San Carlos, CA (US); Steve Parker, Centerville, UT (US); David Kammer, Seattle, WA (US); David Moore, Riverton, UT (US)

Correspondence Address: WAGNER, MURABITO & HAO LLP, Two North Market Street, Third Floor, San Jose, CA, 95113, US

(21) Appl. No.: 09/727,983

(22) Filed: Nov. 30, 2000

(51) Int. Cl. H04Q 7/00

(52) U.S. Cl. 455/411; 455/500; 455/556

(57) ABSTRACT

A wireless communication method for secure transmission of data between mobile computing devices. The method includes the step of transmitting a line of sight beam from a first device to a second device to mutually identify the first device and the second device out of a plurality of devices. Once identified, the first and second devices establish an RF communications link between the identified first device and the identified second device. Using the RF communications link, the data transfer is then performed between the first device and the second device. The line of sight beam to select a secure transmission method for the RF communications link can be an IR communications beam. The RF communications link can be a secure RF communications link recognizable only by the first and second devices output of the plurality of devices. The RF communications link can be compatible with a version of the Bluetooth specification. The secure transmission method can be an encryption method for the RF communications link. At least one of the first and second mobile computing device can be a PID (personal information device). At least one of the first and second mobile computing devices can be a cellular telephone. Upon completion of the data transfer, a confirmation can be presented to the user.

### TECHNICAL FIELD

The present invention relates to a system and method by which a mobile computing device may more easily send and receive data. In particular, the present invention relates to a system and method for secure linking of a first mobile computing device to a second mobile computing device to enable wireless data transfer.

### BACKGROUND ART

Personal Information Devices include the class of computers, personal digital assistants and electronic organizers that tend both to be physically smaller than conventional computers and to have more limited hardware and data processing capabilities. PIDs include, for example, products sold by Palm, Inc. of Santa Clara, Calif., under such trademark as Pilot, and Pilot 1000, Pilot 5000, PalmPilot, PalmPilot Personal, PalmPilot Professional, Palm, and Palm III, Palm V, Palm VII, as well as other products sold under such trade names as WorkPad; Franklin Quest, and Franklin Convey.

PIDs are generally discussed, for example, in U.S. Pat. Nos. 5,125,0398; 5,727,202; 5,832,489; 5,884,323; 5,889,888; 5,900,875; 6,000,000; 6,006,274; and 6,034,686, which are incorporated herein by reference. PIDs typically include a screen and data processor, allowing the PID user to operate a substantial variety of applications relating to, for example: electronic mail, a calendar, appointments, contact data (such as address and telephone numbers), notebook records, expense reports, to do lists, or games. PIDs also often include substantial electronic memory for storing such applications as well as data entered by the user. Due to their substantial variety of applications and uses, personal information devices are becoming increasingly widely used.

One popular application of personal information devices is their ability to easily share information with other properly equipped personal information devices. For example, many types of user information such as electronic mail, calendar events, appointments, contact data, and the like exist in the form of digital data files stored within the memory of the personal information device. When equipped with communications hardware/software, the data files embodying the user information can be easily transferred from one personal information device to another. For example, one such application involves the transferring of electronic “business cards” from one personal information device to another, allowing their respective users to easily exchange contact information.

Infrared (IR) communications technology is one popular means for enabling the wireless transfer of digital data files between personal information devices. When properly configured, one device can transfer selected user information (e.g., electronic business cards) to another device quickly and wirelessly. For example, the user can access a menu of user information via a graphical user interface (GUI) of the personal information device. The user selects one or more items for transfer and beams the data file to the other personal information device. The use of IR communications technology to effect such transfers is well known.

RF communications technology provides another method for enabling the wireless transfer of digital data files between personal information devices. RF communications function in a manner similar to IR communications, in that when devices are properly equipped, one device can transfer selected user information (business cards, etc.) to another device wirelessly. Data selection and beaming can be controlled via GUI menus of the personal information device.

However, RF communications beaming techniques are not readily suited for privacy. For example, due to the broadcast nature of RF transmissions, data beamed from a transmitting device tends to be available to other devices over a wide area. A transmitting device can have a large number of potential receiving devices within communications range of the RF transmission. Thus, RF based transmissions from one device to another are not as secure as a similar IR transmission from one device to another. The range and line of sight requirements/restrictions provide a relatively large degree of security.

Thus, what is required is a solution that allows the secure wireless transfer of data between personal information devices without imposing constant line of sight restrictions. What is required is a solution that allows secure data transfer between personal information devices without imposing constant, very short-range distance requirements. The required solution should be secure and determinative with respect to selecting the intended recipient in comparison to prior art wireless beaming techniques. The present invention provides a novel solution to the above requirements.

### SUMMARY OF THE INVENTION

The present invention is a method and system for a method and system for applying line of sight IR selection of a receiver to implement secure transmission of data to a mobile computing device via an RF link. The present invention provides a solution that allows the secure wireless transfer of data between personal information devices without imposing constant line of sight restrictions. The present invention provides a solution that allows secure data transfer between personal information devices without imposing constant, short-range distance requirements. Additionally, the solution of the present invention is secure and determinative with respect to selecting the intended recipient in comparison to prior art wireless beaming techniques.

In one embodiment, the present invention is implemented as a wireless communication method for secure transmission of data between mobile computing devices. The method includes the step of transmitting a line of sight beam from a first device to a second device to mutually identify the first device and the second device out of a plurality of devices. Once identified, the first and second devices establish an RF communications link between the identified first device and the identified second device. Using the RF communications link, the data transfer is then performed between the first device and the second device. The line of sight beam to select a secure transmission method for the RF communications link is an IR communications beam. The RF communications link is a secure RF communications link recognizable only by the first and second devices output of the plurality of devices. The RF communications is compatible with a version of the Bluetooth specification. The secure transmission method is an encryption method for the RF communications link. Typically, one of the mobile computing devices is a PID or a cellular telephone. Upon completion of the data transfer, a confirmation can be presented to the user.

In this manner, the transmitting device can perform secure data transfers to the receiving device without being constrained by the constant line-of-sight and distance requirements of IR communication. Distance and line-of-sight need be within specified IR tolerances only for the initial identification and selection of secure transmission method. Once mutually identified, the two device need merely stay within RF communcations range. Thus, the user obtains the benefits of the wide, non-line-of-sight coverage of RF based communcation while retaining the security of point-to-point, line-of-sight IR based communication.

### BRIEF DESCRIPTION OF THE DRAWINGS

The present invention is illustrated by way of example and not by way of limitation in the figures of the accompanying drawings, in which like reference numerals refer to similar elements, and in which:

FIG. 1 is a diagram illustrating an exemplary preferred embodiment of the present system.

FIG. 2 is a block diagram illustrating the layers of a radio frequency protocol stack used in the PID of FIG. 2.

FIG. 3 shows a stack layer diagram illustrating the layers of an RF protocol stack in accordance with one embodiment of the present invention.

FIG. 4 is a stack layer diagram illustrating layers of an Infrared Data Association protocol stack used in the PID of FIG. 2.

FIG. 5 is a block diagram of the system of FIG. 1.

FIG. 6A shows a diagram of a multiple recipient data transfer operation in accordance with one embodiment of the present invention.

FIG. 6B shows a first GUI dialog box in accordance with one embodiment of the present invention.

FIG. 6C shows a second GUI dialog box in accordance with one embodiment of the present invention.

FIG. 7 is a flowchart illustrating an exemplary method for the system of FIG. 6A to execute data transfers to a single recipient or multiple recipients in accordance with one embodiment of the present invention.

### DETAILED DESCRIPTION OF THE INVENTION

In the following detailed description of the present invention, a method and system for applying line-of-sight IR selection of a receiver to implement secure transmission of data to a mobile computing device via an RF link, numerous specific details are set forth in order to provide a thorough understanding of the present invention. However, it will be obvious to one skilled in the art that the present invention may be practiced without these specific details. In other instances well known methods, procedures, components, and circuits have not been described in detail as not to obscure aspects of the present invention unnecessarily.

Some portions of the detailed descriptions which follow are presented in terms of procedures, logic blocks, processing, and other symbolic representations of operations on data bits within a computer memory. These descriptions and representations are the means used by those skilled in the data processing arts to convey most effectively the substance of their work to others skilled in the art. A procedure, logic block, process, step, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “implementing,” “transferring,” “executing,” “configuring,” “initializing,” or the like, refer to the actions and processes of an embedded computer system, or similar embedded electronic computing device, that manipulates and transforms data represented as physical (electronic) quantities within the computer system's registers and memories into other data similarly represented as physical quantities within the computer system memories or registers or other such information storage, transmission or display devices.

The present invention is a method and system for a method and system for applying line-of-sight IR selection of a receiver to implement secure transmission of data to a mobile computing device via an RF link. The present invention provides a solution that allows the secure wireless transfer of data between personal information devices without imposing constant line-of-sight restrictions. The present invention provides a solution that allows secure data transfer between personal information devices without imposing constant, very short-range distance requirements. Additionally, the solution of the present invention is secure and determinative with respect to selecting the intended recipient in comparison to prior art wireless beaming techniques. Embodiments of the present invention and its benefits are further described below.

It should be noted that the method and system of the present invention can be configured to enable secure wireless communication between a number of types of mobile computing devices. Such mobile computing devices include, for example, personal information devices (PIDs), handheld cellular telephones (cellphones) and other types of mobile telephones, alphanumeric paging devices, and the like.

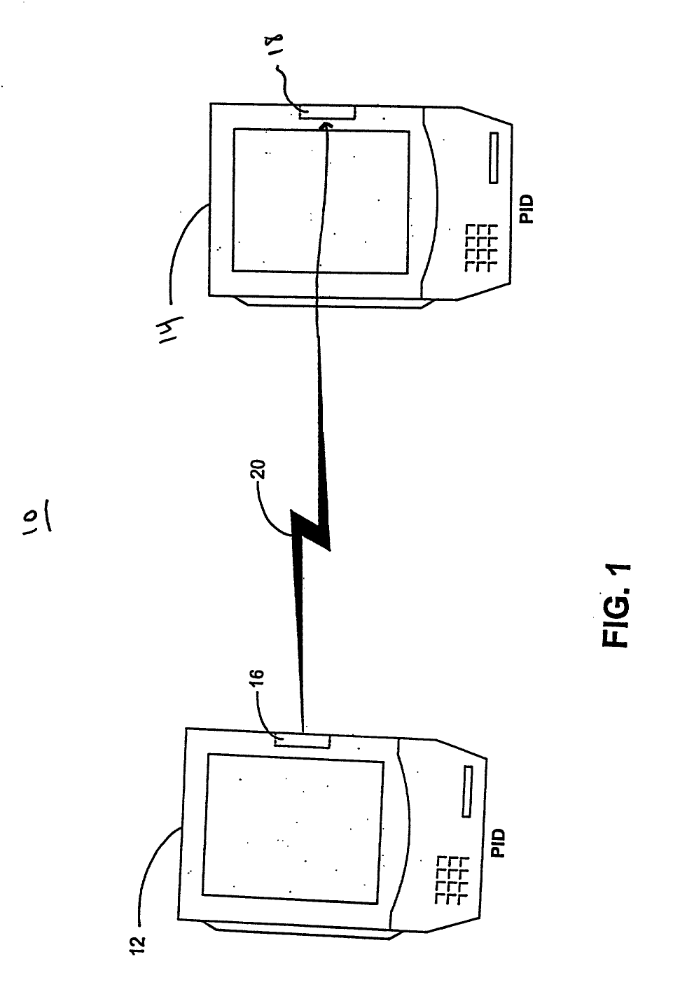

FIG. 1 shows an exemplary embodiment of a system 10 in accordance with one embodiment of the present invention. The system 10 includes a handheld PID 12 and a PID 14. As described above, the preferred embodiment utilizes a PID 12 communicatively coupled to a second PID 14. However, many electronic devices, such as digital cameras, limited feature pagers, laptop computers, and the like, are similar to many PIDs in that they can exchange and make use of the scheduling information contained within a user PID. Limited-feature devices may also be enhanced by coupling the devices with a PID in accordance with the present invention to exchange and view data stored on the PID.

As shown in FIG. 1, the PID 12 of the present system 10 includes a wireless port, or transceiver, 16 (used herein to mean some combination of a receiver and/or transmitter). The PID 14 has a corresponding wireless port, or transceiver, 18 such that a wireless link 20 is established between the PID of 14 and PID 12.

In one preferred embodiment, the wireless ports 16, 18 each include a short-range radio frequency (RF) transceiver. The wireless transceiver 16, 18 establish an RF link, such as that defined by the Bluetooth communications specification. Additionally, the link 20 can also include support for other modes of communication, including an infrared communication links such as that as defined by the Infrared Data Association (IrDA).

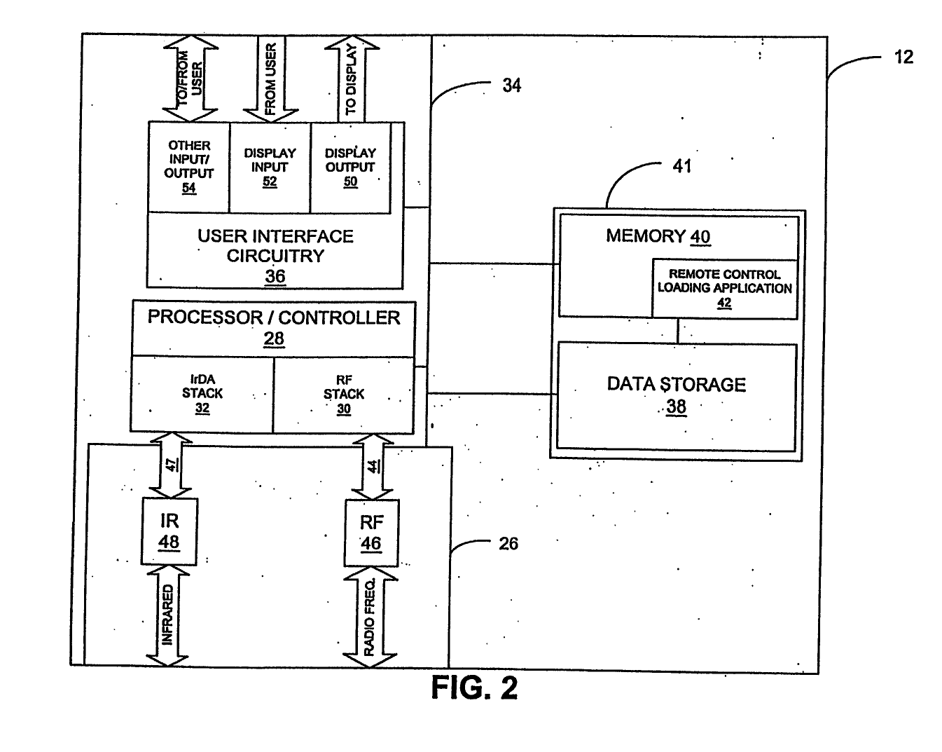

FIG. 2 is a function block diagram showing an exemplary embodiment of the PID 12 that can communicate with the PID 14 or other such devices. The link interface circuitry 26 illustrates, but is not limited to, two alternative link interfaces for establishing a wireless link to another device. One wireless link interface (or more than two link interfaces) may, of course, be used with the present system 10.

The PID 12 includes a processor, or controller, 28 that is capable of executing an RF stack 30 and an IrDA stack 32. The stacks 30, 32 communicate with data interface circuitry 26 through a bus 34. The processor 28 is also connected through the bus 34 to user interface circuitry 36, a data storage module 38 and memory 40. As used herein, the data storage module 38 and memory 40 may both generally be referred to as part of the PID memory 41.

The memory 40 may contain a specific remote control loading application 42. The remote control loading application 42 may operate, for example, after the processor 28 receives a message for the user to establish a wireless link with the PID 14 in the nearby environment. Alternatively, the remote control loading application 42 may operate in a PID default mode.

The data interface circuitry 26 includes, in this exemplary embodiment, a first and second port, such as, infrared and RF interface ports. The first wireless link interface, the RF link interface, may include first connection 44 which includes radio-frequency (RF) circuitry 46 for converting signals into radio-frequency output and for accepting radio-frequency input. The RF circuitry 46 can send and receive RF data communications via a transceiver that are part of the communication port 16. The RF communication signals received by the RF circuitry 46 are converted to electrical signals and relayed to the RF stack 30 in processor 28 via the bus 34.

The PID 14 includes a corresponding port, or transceiver, 18 for RF signals. Thus, the RF 24 and wireless link 20 between the PID 12 and PID 14 may be implemented according to the Bluetooth specification, described at www.bluetooth.com, which is incorporated in its entirety into this document.

Bluetooth is the protocol for a short-range radio link intended to replace the cable(s) connecting portable and/or fixed electronic devices. Bluetooth technology features low power, robustness, low complexity and low cost. It operates in the 2.4 Ghz unlicensed ISM (Industrial, Scientific and Medical) band. Devices equipped with Bluetooth are capable of exchanging data at speeds up to 720 kbps at ranges up to 10 meters. It should be noted that higher power devices other than the typical Bluetooth enabled PID, such as, for example, a network access point, may communicate via Bluetooth with an RF-enabled PID over a greater range, such as, for example, approximately 100 meters.

A frequency hop transceiver is used to combat interface and fading. A shaped, binary FM modulation is applied to minimize transceiver complexity. A slotted channel is applied with a nominal slot length of 625 μs. For full duplex transmission, a Time Division Duplex scheme is use. On the channel, information is exchanged through packets. Each packet is transmitted in a different hop frequency. A packet nominally covers a single slot, but can be extended to cover up to five slots.

The Bluetooth protocol uses a combination of circuit and packet switching. Slots can be reserved for synchronous packets. Bluetooth can support an asynchronous data channel, up to three simultaneous voice channels, or a channel, that simultaneously supports asynchronous data and synchronous voice. Each voice channel supports a 64 kb/s synchronous (voice) channel in each direction. The asynchronous channel can support maximum 723.2 kb/s asynchronous, or 433.9 kb/s symmetric.

The Bluetooth system consists of a radio unit, a link control unit, and a support unit for link management and host terminal interface functions. The link controller carries out the baseboard protocol and other low-level routines.

The Bluetooth system also provides a point-to-point connection (only two Bluetooth units involved) or a point-to-multipoint connection. In point-to-multipoint connections, the channel is shared among several Bluetooth units. Two or more units sharing the same channel form a piconet. One Bluetooth unit acts as the master of the piconet, whereas the other units act as slaves. Up to seven slaves can be active in a piconet.

The Bluetooth link controller has two major states: STANDBY and CONNECTION. In addition, there are seven substances: page, page scan, inquiry, inquiry scan, master response, slave response, and inquiry response. The substances are interim states that are used to add new slaves to the piconet.

The STANDBY state is the default state in the Bluetooth unit. In this state, the Bluetooth unit is in a low-power mode. The controller may leave the STANDBY state to scan for page or inquiry messages, or to page or inquiry itself. When responding to a page message, the unit enters the CONNECTION state as a master.

In order to establish new connections, the inquiry procedures and paging are used. The inquiry procedures enable a unit to discover which units are in range, and what their device address and clocks are during an inquiry substate, the discovering unit collects the Bluetooth device addresses and clocks of all units that respond to the inquiry message. It can then, if desired, make a connection to any one of them. The inquiry message broadcasted by the source does not contain and information about the source. However, it may indicate which class of devices should respond.

There is one general inquiry access code (GIAC) to inquire for any Bluetooth device, and a number of dedicated inquiry access codes (DIAC) that only inquire for a certain type of devices. A unit that wants to discover other Bluetooth units enters an inquiry substate. In this substance, it continuously transmits the inquiry message (which is an identification packet) at different hop frequencies. A unit that allows itself to be discovered, regularly enters the inquiry scan substance to respond to inquiry messages.

A second connection 46 includes infrared circuitry 48 for converting signals into infrared output and for accepting infrared input. Thus, the wireless link 28 can include an infrared interface. The infrared circuitry 48 can send and receive infrared data communications via the port, or transceiver, 16.

Infrared communication signals received by infrared circuitry 48 are converted into electrical signal that are relayed to the IrDA stack 32 in the processor, or controller, 28 via the bus 34. The PID 14 may include a corresponding infrared transceiver. The infrared circuitry 48 operates according to the IrDA specifications available at www.IrDA.org.

It should be noted that the specific format of the two link interfaces described above can be altered in accordance with the specific needs of the user, and as such, additional means for implementing the interface between a PID and telephone or other such device may be utilized. In the present embodiment, the RF (Bluetooth) link is wide area, non-line-of-sight and the IR (IrDA) link is point-to-point, line-of-sight. The two wireless links are used to implement the secure data transmission method of the present invention.

User interface circuitry 36 in the PID 12 included hardware and software components that provide user input and output resources for functions in the processor 28. The user interface circuitry 36 includes display output 50, display input 52, and additional input/output interface circuitry 54.

The display output 50 preferably receives digital information representing graphical data from the processor 28 and converts the information to a graphical display, such as text and or/images, for display on a display screen. The display input 52 may receive data inputs, such as graphical data inputs, from a user of the PID 12. The graphical data inputs are preferably entered by the user with a stylus on a pressure sensitive display screen, and may include text, drawings, or other objects that are capable of being graphically presented.

Typically, the additional input/output interface 54 permits user input and commands to be input through buttons and similar devices on the PID, e.g., buttons for scrolling through data entries and activating applications. Alternatively, the input/output interface 54 may allow the PID 12 to accept audio data as well as other types of non-graphical data. For example, audio data signals (or picture telephone video input) may be entered through the additional input/output interface 54.

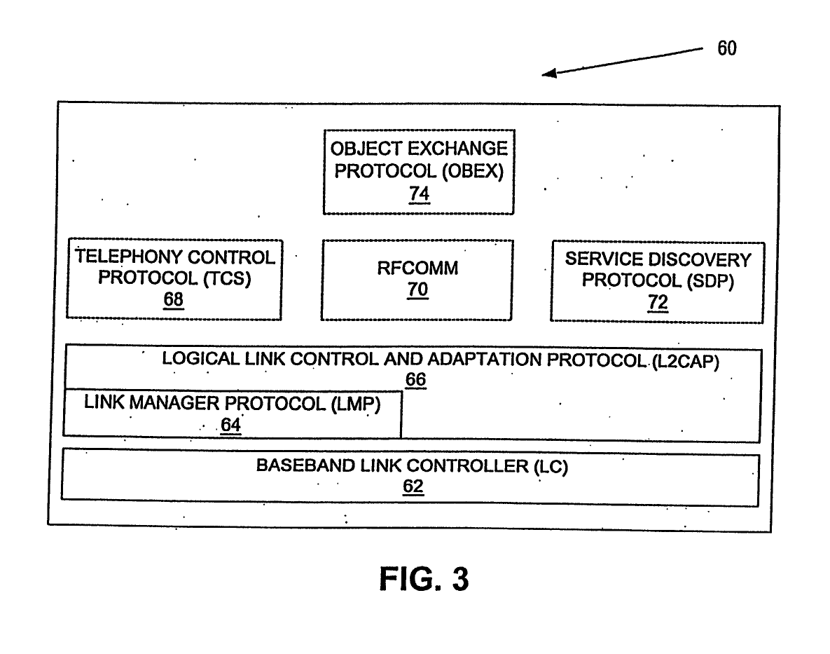

FIG. 3 shows a diagram illustrating the layers of the Bluetooth (RF) protocol stack 60 in accordance with one embodiment of the present invention. An RF protocol stack is implemented at each end of the connection endpoints of an RF link. For example, a PID 12 and a telephone 14 could each implement an RF stack to enable a link. The required layers of the RF link using the Bluetooth system are the Baseband layer 62, the Link Manager Protocol Layer (LMP) 64, the Logical Link Control and Adaptation Layer 68, RFCOMM Layer 70, Service Discovery Protocol Layer 72, and Object Exchange Protocol (OBEX) layer 74.

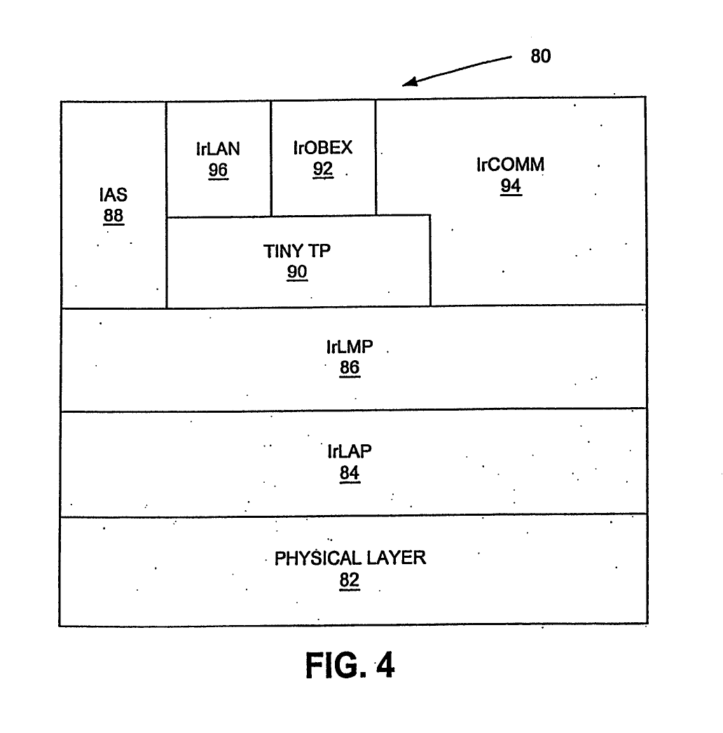

FIG. 4 is a protocol diagram 80, illustrating the layers of the IrDA protocol stack that may be used with the system 10. For example, the PID and the telephone 41 each implement an IrDA protocol stack to enable the wireless link 20.

The required layers of an IrDA protocol stack are the physical layer 82, the IrLMP layer 84, the IrLMP layer 86 and the LAS layer 88. The physical layer 82 specifies optical characteristics if the link, encoding of the data, and framing for various speeds. The IrLAP (Link Access Protocol) layer 84 establishes the basic reliable connection between the two ends of the link. The IrLMP (Link Management Protocol) layer 86 multiplexes services and applications on the IrLAP connection. The IAS (Information Access Service) layer 88 provides a directory of services on an IrDA device.

The IrDA protocol also specifies a number of optional protocol layers, these protocol layers being TINY TP90, IrOBEX 92, IrCOMM 94 and IrLAN 96. TINY TP (Tiny Transport Protocol) 90 adds per-channel flow control to keep traffic over the link 20 moving smoothly. IrOBEX (Infrared Object Exchange Protocol) 92 provides for the easy transfer of files and other data objected between the IrDA devices at each end of the applications that use serial and parallel communications to use IrDA without change. IrLAN (Infrared Object Exchange Protocol) 92 provides for the easy transfer of files and other data objects between the IrDA devices at each end of the link 20. IrCOMM 94 is a serial and parallel communications to use IrDA without change. IrLAN (Infrared Local Area Networks) 96 enables walk-up infrared LAN access.

The use of the optional layers depends upon the particular application in the IrDA device. The IrDA protocol stack is defined by such standard documents as “IrDA Serial Infrared Physical Layer Link Specification”, “IrDA ‘IrCOMM’: Serial and Parallel Port Emulation over IR (wire replacement)”, “IrDA Serial Infrared Link Access Protocol (IrLAP)”, “IrDA Infrared Link Management Protocol(IrLMP)”, and “IrDA ‘TINY TP”: A Flow-Control Mechanism for use with IrLMP, and related specification published by the IrDA. Such documents are available at www.irda.org/standards/specifications.asp and are incorporated in their entirety in this document.

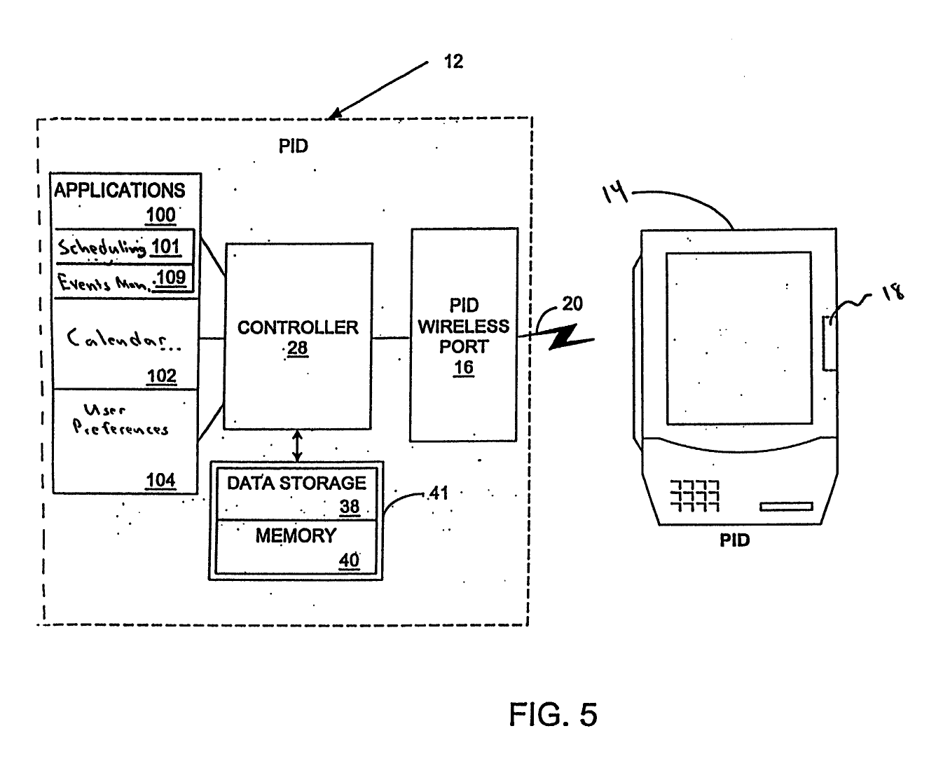

As shown in FIG. 5, the PID 12 may include resident applications 100,. such as, for example, a scheduling program 101 for managing schedule information. The PID 12 may include as well, for example, an events management program 109 for recording the start time and stop time of special events, a calendar program 102 for assisting in managing scheduling and events, and a user preferences program 104 for configuring PID 12 in accordance with the requirements of the user.

PID 12 and PID 14 implement the secure communication method of the present invention. PID 12 uses a line-of-sight IR communication with PID 14 in order to mutually select each other and set up the parameters (e.g., encryption, coding, etc.) for implementing a secure transmission of data via an RF link 20. In the present embodiment, the IR communication is in accordance with the IrDA protocols described above, and the RF communication is in accordance with the Bluetooth specifications described above.

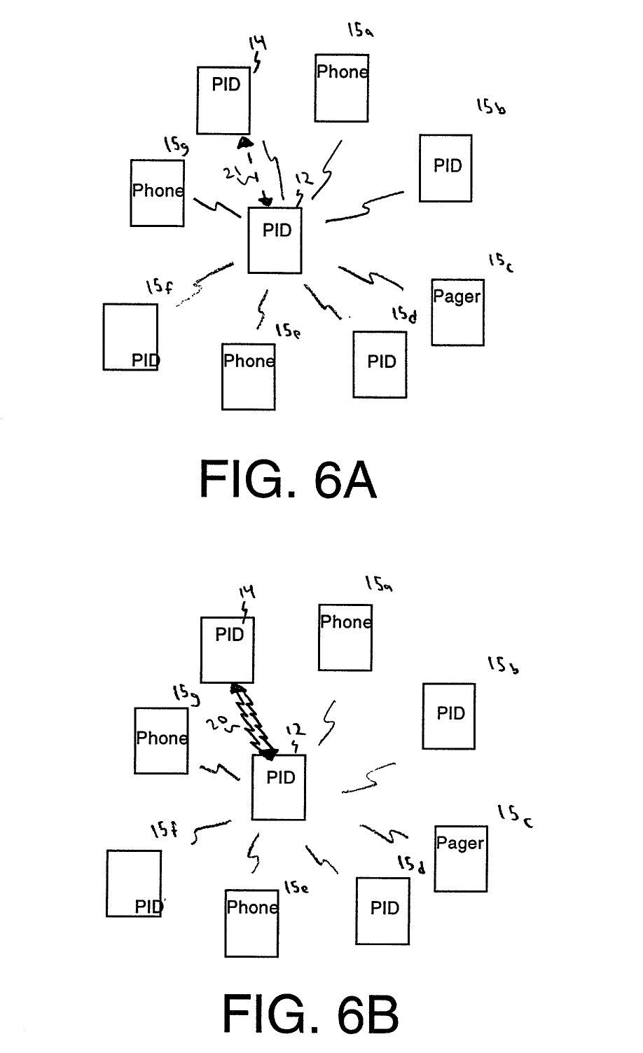

Referring still to FIG. 5, with the advent of short-range RF data transmission enabled by by the Bluetooth standard comes a benefit that can also be a problem. Bluetooth allows RF data transmission without the line-of-sight required for IR data transmissions. In most situations, the non-line-of-sight characteristics of RF data transmission are beneficial. RF data transmission enables the “beaming” of data without users having to point their devices (e.g., PID 12 and PID 14) directly at each other. However, there are times when a user will want to select the device intended for receipt of RF data by manually pointing to the receiving device. For example, imagine that a user wants to RF-beam “e-cash” to a cash register, or RF-beam confidential information to a previously unknown/unrecognized Bluetooth enabled Network Access Point. It is important that the e-cash not be beamed to the wrong cash register and the confidential information not be beamed to an unintended recipient. The secure data transmission method of the present invention solves this problem by using a line-of-sight IR link to identify an intended recipient and set up the parameters for a secure RF data transmission. This scenario is diagrammed in FIG. 6A and FIG. 6B below.

Referring now to FIG. 6A and FIG. 6B, a diagram depicting the operation of the secure transmission method of the present invention is shown. FIG. 6A shows PID 14 and PID 12. Within communications range of PID 14 are also mobile computing devices (e.g., PIDs, cellphones, pagers) 15a-g. The user of PID 12 selects PID 14 by establishing a line-of-sight IR communications link 21. The link is established by, for example, pointing the wireless port of PID 12 directly at the the corresponding wireless port of PID 14. Devices 15a-g cannot establish an IR link since they are not within line-of-sight (e.g., not pointed at). In this manner, IR communications link 21 functions as the initial selector and identifier of the recipient, PID 14. Referring now to FIG. 6B, once the receiving device has identified itself with, for example, a Bluetooth identifier, the receiving device and the transmitting device can bond themselves to each other such that the transmitting device will RF beam information only to that device. PID 12 and PID 14 exchange information to enable the implementation of a secure RF link 20. This information can be mere Bluetooth device identifiers, or can be encryption codes, or other secure data transmission means. Once established, the secure RF communications link 20 enables private communication between PID 12 and PID 14.

It should also be noted that although the present invention is here described within the context of the Bluetooth Specification and that the underlying technology used to send data objects between devices is described in the context of the Bluetooth Specification, the present invention can be configured to function with other types of RF based communication technologies.

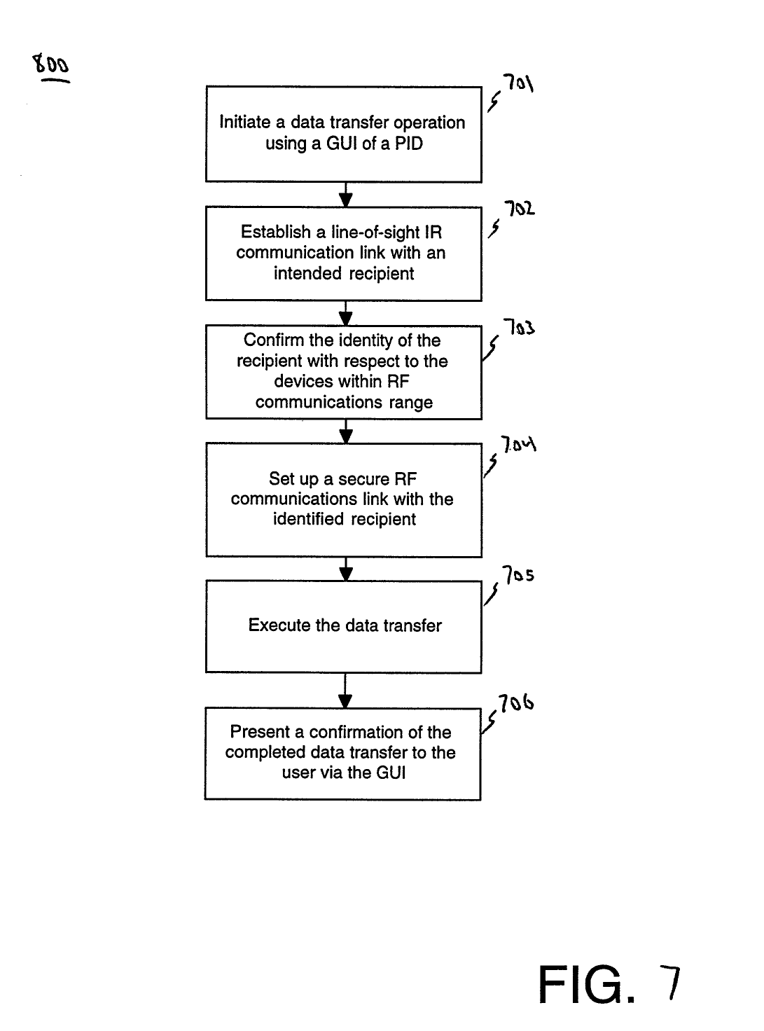

Referring now to FIG. 7, a flow chart of the steps of an RF wireless secure communication process 800 in accordance with one embodiment of the present invention is shown. FIG. 7 depicts the operating steps performed as a user identifies a particular PID using an IR link to establish a secure RF link.

Process 700 begins in step 701, where the user initiates a data transfer operation using a GUI of PID 12. The user, for example, activates a “secure device select” button on the GUI of PID 12 and points PID 12 at the intended recipient (e.g., PID 14). In step 702, once line-of-sight is established between PID 12 and PID 14, an IR communications link is established. In step 703, PID 12 presents a confirmation dialog box to the user, for example, asking the user if indeed PID 14 is the intended recipient. In step 704, once confirmed, PID 12 and PID 14 set up a secure RF communications link. As described above, the secure link can be established through the exchange of Bluetooth device identifiers, or other more sophisticated encryption techniques. In step 705, once the RF communications link is established, the data transfer is executed. Subsequently, in step 706, PID 12 presents a GUI confirmation of the completed data transfer to the user.

Thus, the present invention is a method and system for a method and system for applying line-of-sight IR selection of a receiver to implement secure transmission of data to a mobile computing device via an RF link. The present invention provides a solution that allows the secure wireless transfer of data between personal information devices without imposing constant line-of-sight restrictions. The present invention provides a solution that allows secure data transfer between personal information devices without imposing constant, very short-range distance requirements. Additionally, the solution of the present invention is secure and determinative with respect to selecting the intended recipient in comparison to prior art wireless beaming techniques.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order best to explain the principles of the invention and its practical application, thereby to enable others skilled in the art best to utilize the invention and various embodiments with various modifications as are suited to the particular use contemplated. It is intended that the scope of the invention be defined by the claims appended hereto and their equivalents.

What is claimed is:

1. A wireless communication method for secure transmission of data between mobile computing devices, comprising the steps of:
a) transmitting a line of sight beam from a first device to a second device to mutually identify the first device and the second device out of a plurality of devices;
b) establishing an RF communications link between the identified first device and the identified second device; and
c) performing the data transfer between the first device and the second device.

2. The method of claim 1 wherein at least one of the first and second mobile computing device is a PID (personal information device).

3. The method of claim 1 wherein at least one of the first and second mobile computing devices is a cellular telephone.

4. The method of claim 1 wherein the RF communications link is a secure RF communications link recognizable only by the first and second devices output of the plurality of devices.

5. The method of claim 1 wherein the RF communications link is compatible with a version of the Bluetooth specification.

6. The method of claim 1 further including the step of using the line of sight beam to select a secure transmission method for the RF communications link.

7. The method of 6 wherein the secure transmission method is an encryption method for the RF communications link.

8. The method of claim 1 wherein the line of sight beam is an IR communications beam.

9. The method of claim 7 further including the step of presenting a confirmation of the data transfer to the plurality of mobile computing devices to the user.

10. The method of claim 1 further including the steps of:
presenting a menu to allow a selection for enabling a wireless RF communications link for performing the data transfer or enabling a wireless IR communications link for performing the data transfer; and
performing the data transfer using the RF communications link or the IR communications link in accordance with the selection.

11. A system for implementing secure wireless transmission of data between mobile computing devices, comprising:
a first mobile computing device having an IR communications port and an RF communications port;
a second mobile computing device having an IR communications port and an RF communications port;
the first mobile computing device configured to transmit and RF beam to the second mobile computing device via their respective IR communications ports to mutually identify the first mobile computing device and second mobile computing device out of a plurality of devices; and
the first and second mobile computing devices further configured to establish a RF communications link via their respective RF communications ports based upon their mutual identification and perform a data transfer using the RF communications link.

12. The system of claim 10 wherein at least one of the first and second mobile computing device is a PID (personal information device).

13. The system of claim 10 wherein at least one of the first and second mobile computing devices is a cellular telephone.

14. The system of claim 10 wherein the RF communications link is a secure RF communications link recognizable only by the first and second devices output of the plurality of devices.

15. The system of claim 10 wherein the RF communications link is compatible with a version of the Bluetooth specification.

16. The system of claim 10 wherein the IR communications link is used to select a secure transmission method for the RF communications link.

17. The system of 16 wherein the secure transmission method is an encryption method for the RF communications link.

18. The system of claim 10 wherein the IR communications link is in accordance with a version of the IrDA specification.
